(19) United States
(12) Patent Application Publication
(10) Pub. No.: US 2008/0229542 A1
(43) Pub. Date: Sep. 25, 2008

(54) Slide Rail

(75) Inventor: Horst Tillmann, Ennepetal (DE)

Correspondence Address: COHEN, PONTANI, LIEBERMAN & PAVANE LLP, 551 FIFTH AVENUE, SUITE 1210, NEW YORK, NY, 10176, US

(73) Assignee: Dorma GmbH + Co. KG, Ennepetal (DE)

(21) Appl. No.: 10/586,110

(22) PCT Filed: Jan. 17, 2005
(86) PCT No.: PCT/EP2005/000391

§ 371 Date: Jul. 14, 2006

(30) Foreign Application Priority Data
Jan. 21, 2004 (DE) 10 2004 003 279.3

(51) Int. Cl. E05F 3/22

(52) U.S. Cl. 16/71

(57) ABSTRACT

A slide channel for a slide member of a door closer, includes a housing having a length and a longitudinal slot extending over the entire length of the housing. The housing includes a support wall, an end wall disposed opposite the support wall, and a top wall disposed opposite the longitudinal slot and connecting the support wall and the end wall. The support wall, the end wall and the top wall define an inner chamber for accommodating the slide member. The support wall has a first height, and the end wall has a second height which is less than the first height.

The invention relates to a slide channel according to the generic part of patent claim 1, as well as to a slide member according to the generic part of patent claim 11.

A slide channel of this type is for example known from DE 37 01 300 A1, FIG. 6 therein. The slide channel has a housing with a rectangular cross-section, resulting in a box-shaped housing form with a somewhat heavy appearance. Within the housing a chamber is provided, wherein a slide member, that is connected to an actuating arm of a door closer, can be displaced in the longitudinal direction of the slide channel.

Therefore, it is an object of the present invention to further develop a slide channel including a slide member according to the type indicated in the generic part of patent claim 1, which has a stylish housing contour combined with an optimized functionality and a matching slide member.

This object is solved by the features of patent claim 1.

As the height of the support wall of the housing of the inventive slide channel is higher than the height of the end wall, which is disposed opposite the support wall, the option is provided to realize a housing contour with a slimmer appearance, leading to a very stylish housing form while having the advantage of resulting in a slightly reduced housing weight, as material can be saved on account of the reduced height of the end wall. Such embodiment will simultaneously provide the support wall with a stable base for fastening at a door or at a wall or the like.

Furthermore, there is the option to impart a roof-shaped contour to the housing of the inventive slide channel.

Preferably, it is possible in this case to further improve the appearance of the housing contour by means of a slightly curved top wall.

Advantageous further developments of the invention are set forth in the dependent claims.

Hereinafter, one exemplary embodiment will be explained in detail based on the drawings, in which:

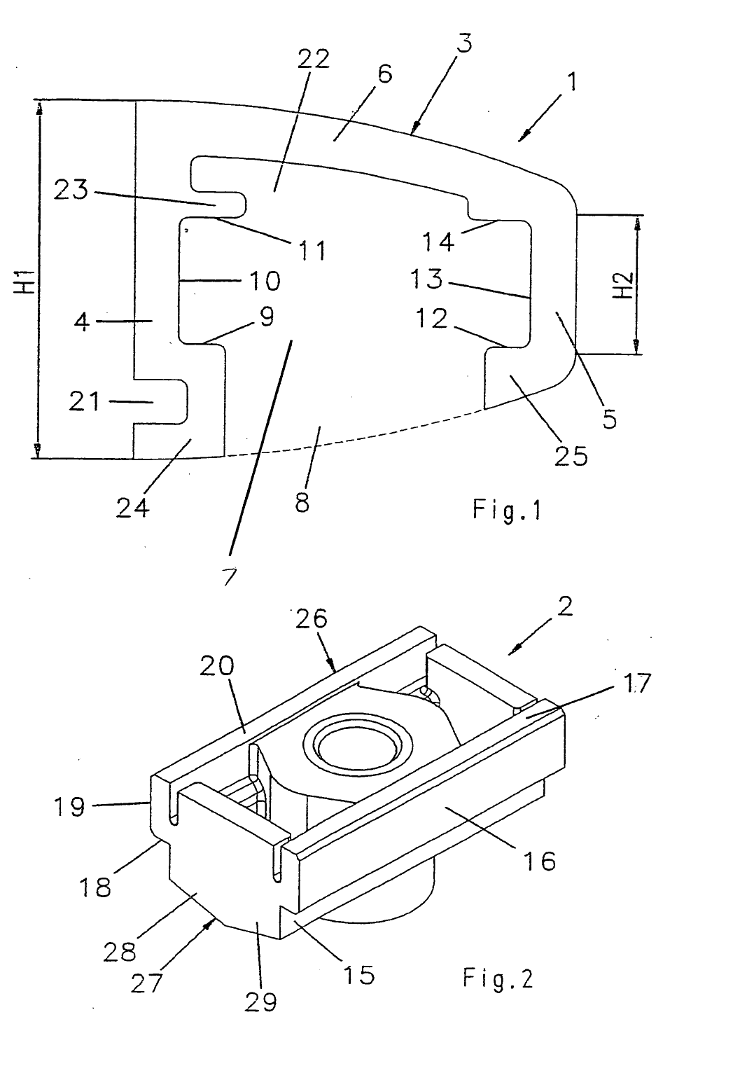

FIG. 1 shows a sectional view of an inventive slide channel, and

FIG. 2 shows a perspective view of a slide member, which can be combined with the slide channel according to FIG. 1.

FIG. 1 is a sectional illustration and shows a slide channel 1 for a slide member 2 of a door closer with a housing 3. The housing 3 has a support wall 4 and an end wall 5 disposed opposite the support wall 4. Furthermore, FIG. 1 shows a top wall 6 connecting the support wall 4 and the end wall 5, an inner chamber 7 for accommodating the slide member 2 and a longitudinal slot 8 disposed opposite the top wall 6 and extending over the entire housing length.

A substantial feature of the present invention is that a height H1 of the support wall 4 is greater than a height H2 of the end wall 5.

FIG. 1 reveals that the form of the top wall 6 is downwardly curved from the support wall 4 towards the end wall 5. As an alternative to this embodiment, however, not illustrated in FIG. 1, the top wall 6 can be formed as downwardly extending flat or concave.

As illustrated in FIG. 1, the inner chamber 7 has guiding surfaces 9 to 14, extending over the entire housing length, for the supporting surfaces 15 to 20 of the slide member 2.

The advantage of a slightly reduced housing weight is achieved in that the support wall 4 has at least one opening 21 for saving on material and the top wall 6 has at least one opening 22 for saving on material.

Furthermore, as can be seen in FIG. 1, the support wall 4 has a rib 23 extending over the entire housing length, at which rib a surface 11 of the first group 9 to 11 of guiding surfaces 9 to 14 is located.

FIG. 1 further reveals that the support wall 4 has a projection 24 extending over the entire housing length and protruding into the inner chamber 7, at which projection the surface 9 of the guiding surfaces 9 to 14 is located, which is opposite the guiding surface 11 located at the rib 23 and extends parallel thereto.

The third surface 10 of the guiding surfaces 9 to 11 is at a right angle in relation to the first and second guiding surface 9, respectively 11. In addition, the second group 12 to 14 of guiding surfaces 9 to 14 has three guiding surfaces 12 to 14, being located at a right angle in relation to each other, the surface 14 of the guiding surfaces 12 to 14 being located at the top wall 6, the second surface 13 at the end wall 5 and the third surface 12 of the guiding surfaces 12 to 14 at a projection 25, which projects from the end wall 5 into the inner chamber 7 and extends over the entire housing length.

FIG. 2 is a perspective illustration of the slide member 2 for the slide channel 1 having a slide channel contour 26, at which the supporting surfaces 15 to 20 are located. Furthermore, a base wall 27 matching the contour of the housing 3 of the slide channel 1 is illustrated.

FIG. 2 further shows that the base wall 27 has two partial walls 28, 29, disposed at an angle in relation to each other. These partial walls 28, 29 may extend straight or curved (radius).

### LIST OF REFERENCE NUMERALS

1 slide channel
2 slide member
3 housing
4 support wall
5 end wall
6 top wall
7 inner chamber
8 longitudinal slot
9-14 guiding surfaces
15-20 supporting surfaces
21, 22 opening
23 rib
24, 25 projection
26 slide channel contour
27 base wall
28, 29 partial walls

1.-13. (canceled)

14. A slide channel for a slide member of a door closer, comprising:
a housing having a length and a longitudinal slot extending over the entire length of the housing, the housing comprising:
a support wall;
an end wall disposed opposite the support wall; and
a top wall disposed opposite the longitudinal slot and connecting the support wall and the end wall,
wherein the support wall, the end wall and the top wall define an inner chamber for accommodating the slide member, and
wherein the support wall has a first height, the end wall having a second height which is less than the first height.

15. The slide channel of claim 14, wherein the top wall is downwardly curved from the support wall toward the end wall.

16. The slide channel of claim 14, wherein the top wall slopes from the support wall toward the end wall.

17. The slide channel of claim 14, wherein the support wall, the end wall and the top wall have a plurality of guiding surfaces extending over the entire length of the housing for the slide member.

18. The slide channel of claim 14, wherein the support wall has at least one trench.

19. The slide channel of claim 14, wherein the top wall has at least one trench.

20. The slide channel of claim 17, wherein the support wall comprises a rib extending over the entire length of the housing, the rib having a surface which forms a first guiding surface of the plurality of guiding surfaces.

21. The slide channel of claim 20, wherein the support wall further comprises a first projection extending over the entire length of the housing and projecting into the inner chamber, the first projection having a surface which forms a second guiding surface of the plurality of guiding surfaces, the second guiding surface being opposite and parallel to the first guiding surface.

22. The slide channel of claim 21, wherein the support wall further has a surface which forms a third guiding surface of the plurality of guiding surface, the third guiding surface being disposed at a right angle with respect to the first and second guiding surfaces.

23. The slide channel of claim 22, wherein the end wall comprises a second projection extending over the entire length of the housing and projecting into the inner chamber, the second projection having a surface which forms a fourth guiding surface of the plurality of guiding surfaces, wherein the top wall has a surface which forms a fifth guiding surface of the plurality of guiding surface, and wherein the end wall further has a surface which forms a sixth guiding surface of the plurality of guiding surface, the fourth and fifth guiding surfaces facing each other and being perpendicular to the six guiding surface.

24. A slide member for the slide channel of claim 14, having a slide channel contour with a plurality of supporting surfaces, the slide member comprising a base wall which matches a contour of the housing of the slide channel.

25. The slide member of claim 24, wherein the base wall comprises two partial walls which are disposed at an angle with each other.

26. The slide member of claim 24, wherein the base wall has a curved shape.
